(19) United States
(12) Patent Application Publication
(10) Pub. No.: US 2010/0230915 A1
(43) Pub. Date: Sep. 16, 2010

(54) Tilting vehicle

(76) Inventor: Nicolas Antoun Abouchaar, (US)

Correspondence Address: Nicolas Abouchaar;Ziad yammine, 1850 Hampstead drive, Colombus, OH, 43229, US

(21) Appl. No.: 12/697,287

(22) Filed: Jan. 31, 2010

(30) Foreign Application Priority Data
Jan. 31, 2009 (DE) 10 2009 042 429.6

(51) Int. Cl. B62B 13/12

(52) U.S. Cl. 280/22.1

(57) ABSTRACT

A tilting vehicle for the transport of at least one passenger on snow, ice, grass, sand or water is disclosed. It comprises a frame, one steering ski, two tilting skis, two tilting arms, a tilting control device, and connecting elements. The steering ski is used to change the direction of travel. The tilting control device, which is pivot-mounted on the frame, is connected to the tilting arms using connecting elements. Each tilting ski is mounted at one first end of each tilting arm. The tilting arms with their respective second ends are pivot-mounted on the frame around an upper pivot. By pivoting the tilting control device, the two tilting skis can be vertically adjusted to the frame in opposite directions, such as to allow a vertical adjustment of the tilting skis with respect to the frame, resulting in tilting the vehicle frame with respect to the ridden slope, procuring thereby a very stable movement. This tilting vehicle can be used to roll on the ground by having wheels instead of the skis.

### FOREIGN APPLICATION PRIORITY DATA

Jan. 31, 2009 [DE] 10 2009 042 429.6

### REFERENCES CITED

### U.S. Patent Documents

U.S. Pat. No. 3,398,970 A

### Foreign Patent Documents

DE 928 569 B

DE 297 22 354 U1

DE 201 17 868

### BACKGROUND OF THE INVENTION

This invention relates to a tilting vehicle that can be used to slide on snow, ice, grass, sand or water, or to roll on the ground using wheels.

Various tilting vehicles allowing a controlled movement over snow slopes are already known. In particular, tilting vehicles are known which, on one hand allow a controlled change of direction, and on the other hand an adjustment of the tilting vehicle such as to also allow a transversal movement on slopes having different inclinations.

In both U.S. Pat. No. 3,398,970 A and DE 928 569 B, a tilting vehicle allowing the transport of a sitting person is described, wherein this device comprises a frame, a centrally positioned steering ski which can be steered by hand, as well as two rear skis which are parallel to each other. In this device, all three skis can be pivoted around an axis, which runs parallel to the tilting skis 4, such as to allow them to cant, thereby creating a sharp edge with the snow. The canting movement can be steered independently of the steering movement.

A similar concept is described in the patent application DE 297 22 354 U1, wherein only the rear skis are canted, i.e. catch an edge with the slope; this canting movement is triggered by the steering movement of the steering ski.

Another skiing device is described in the patent application DE 201 17 868 U1, whereby the passenger is transported in a standing position. Both rear skis are parallel to each other, wherein these skis are connected to a frame by means of two tilting arms and a pivot, wherein the pivot is oriented in a transversal direction. In order to adjust this skiing device to the angle of a slope, the rear skis can be moved vertically, wherein the upward vertical translation of one rear ski triggers an equal downward vertical translation of the other rear ski.

None of the above patents or products, taken singularly or in combination is seen to describe the present invention as disclosed and claimed.

### BRIEF SUMMARY OF THE INVENTION

Accordingly, it is an object of the invention to provide a very stable tilting vehicle for the transport of passengers which allows, in an intuitively easy way, a steering movement procuring a change in the direction of travel, as well as a thereof independent tilting movement, which allows an adequate adherence on the ridden slope irrespective of the direction of travel relative to the ridden slope, i.e. whether downwards, sideways, or crosswise.

According to the invention, this is achieved by a tilting vehicle which comprises mainly a frame, one steering ski, two tilting skis, two tilting arms, a tilting control device, and connecting elements. The steering ski is used to change the direction of travel. The tilting control device, which is pivot-mounted on the frame, is connected to the tilting arms using connecting elements. Each tilting ski is mounted at one first end of each tilting arm 2. The tilting arms with their respective second ends are pivot-mounted on the frame around an upper pivot. By pivoting the tilting control device, the two tilting skis can be vertically adjusted to the frame in opposite directions, such as to allow a vertical adjustment of the tilting skis with respect to the frame, resulting in tilting the whole vehicle frame with respect to the ridden slope, procuring thereby a very stable movement. This tilting vehicle can be used to roll on the ground by having wheels instead of the skis.

### BRIEF DESCRIPTION OF THE DRAWINGS

The foregoing and other objects, aspects and advantages will be better understood from the following detailed description of the three following embodiments of the invention with reference to the accompanying drawings, in which:

FIGS. 1 to 7 refer to the 1^{st} Embodiment:

FIG. 1 is an isometric view of the tilting vehicle, from the front side,

FIG. 2 is an isometric view of the tilting vehicle, from the rear side,

FIG. 3 is a top view of the tilting vehicle,

FIG. 4 is a side view of the tilting vehicle,

FIG. 5 is an isometric view of the frame of the tilting vehicle,

FIG. 6 is a detailed view of the steering ski,

FIG. 7 is an isometric view of the tilting vehicle, showing both steering and tilting movements,

FIG. 8 is a rear view of the tilting vehicle, showing both steering and tilting movements,

FIG. 9 is a rear view of the tilting vehicle, showing the tilting movement,

FIG. 10 is a front view of the tilting vehicle shown in a folded configuration,

FIGS. 11 and 12 refer to the 2^{nd} Embodiment:

FIG. 11 is an isometric view, from the front side, of the tilting vehicle with a manual steering function, showing both steering and tilting movements, FIG. 12 is a front view of the tilting control device of the tilting vehicle shown in FIG. 10,

FIGS. 13 and 14 refer to the 3^{rd} Embodiment:

FIG. 13 is an isometric view of the tilting vehicle (wheel version),

FIG. 14 is an isometric view of the tilting vehicle (wheel version), showing both steering and tilting movements.

### DETAILED DESCRIPTION OF THE INVENTION

In the following text, direction of travel 14 refers to the actual direction in which the centre of gravity of the tilting vehicle is moving. The terms “front” and “rear” in the present description and the following claims are relative to the direction of travel 14.

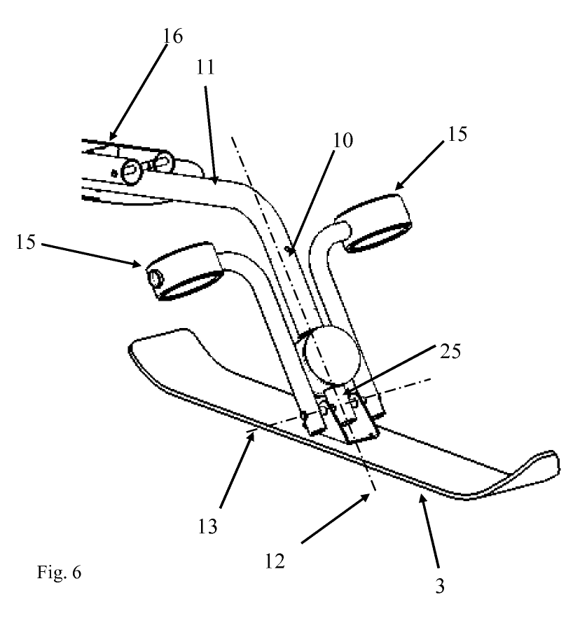

Frame direction 9 refers in the following text to a direction, which lies in the plane of the flat terrain, on which the tilting vehicle is moving. The frame direction 9 extends parallel to the longitudinal direction of both tilting skis 4, thereby pointing at least partially in the direction of travel 14 please refer to FIG. 6).

### 1^{st} Embodiment

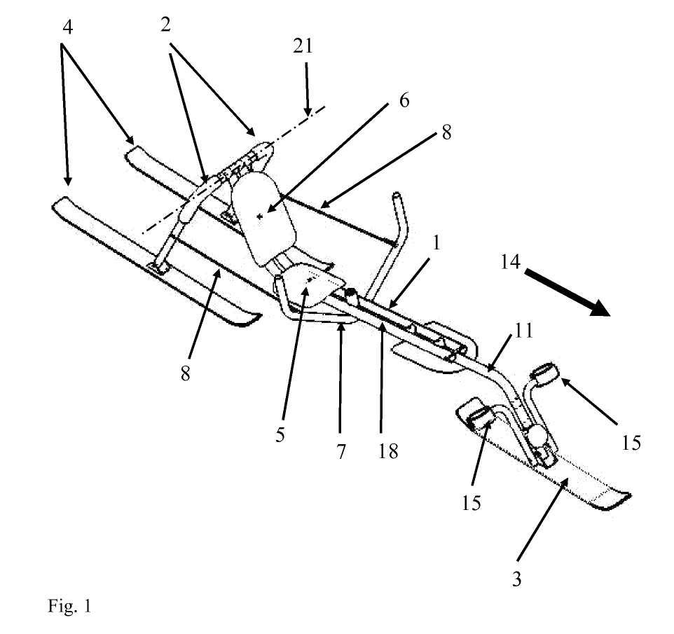

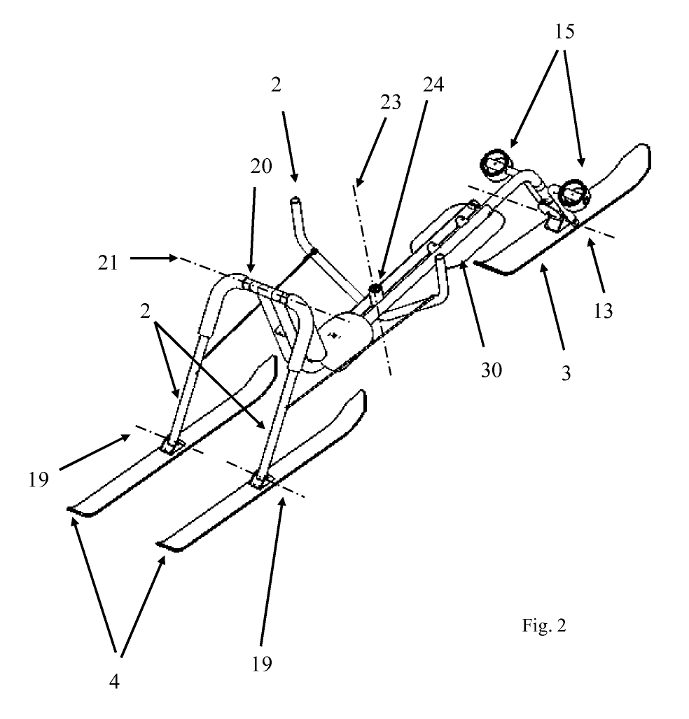

The tilting vehicle shown in FIGS. 1 and 2 comprises a frame 1, on which a steering ski 3, a seat 5, a back rest 6, two tilting arms 2 and a tilting control device 7 are mounted.

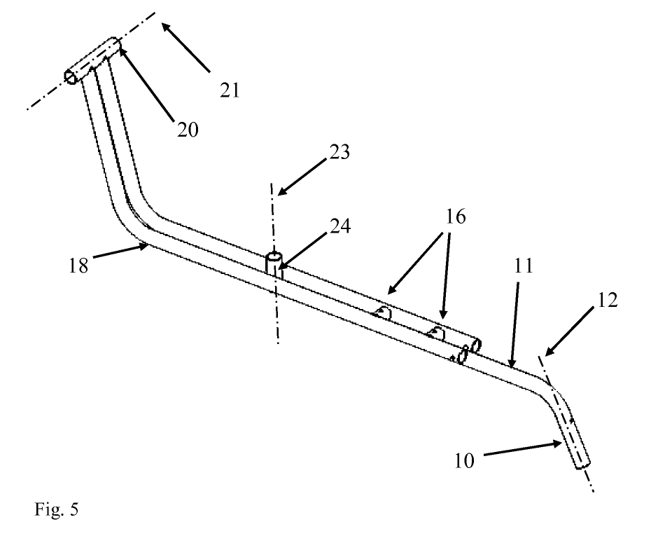

The frame 1 (please refer to FIG. 5) is made of a rear tubes assembly and of one single front tube 11. The rear tube assembly comprises the rear tubes 18, an upper pivot receptacle 20, and a middle pivot receptacle 24. The front tube integrates, at its front end, the front pivot receptacle 10.

The tilting control device 7 is pivot-mounted in the middle pivot receptacle 24. The latter extends in such a direction such that the plane passing through the tilting control device 7 is normal to the longitudinal extension of the rear tubes 18 (please refer to FIGS. 4 and 5).

The frame 1 can be made of metal, particularly aluminum or steel; it can also be made of a plastic material or of light-weight material like carbon fiber. The frame 1 has an S shape (please refer to FIG. 4), wherein its linear ends extend in parallel directions.

A seat 5, on which the passenger can sit during the travel, is fixed on the rear tubes 18 of the frame 1. The back rest 6 insures more comfort for the passenger. For the transport of more passengers, one seat and one back rest for each passenger can be fixed on the frame 1.

The seat 5 and back rest 6 can also be integrated in the frame 1, depending on the material used to manufacture the frame 1. Plastic materials which are injection molded or blow molded are the most adequate for this purpose.

A steering ski 3 is mounted at the front tube of the frame 1; on the rear end of the frame 1, two tilting skis 4, parallel to each other, are mounted by means of the tilting arms 2. The tilting control device 7 is pivot-mounted on the frame 1 around a middle pivot 23. In FIGS. 1 and 2, the tilting control device 7 is shown in a symmetric position with respect to the frame 1; both tilting arms 2 feature therefore the same angle with respect to the frame 1.

The undersides of the steering and tilting skis 3, 4 constitute a plane, which is identical with the flat terrain surface.

### Steering Function (Please Refer in Particular to FIG. 6):

The steering ski 3 is pivot-mounted with respect to the frame 1 around a first front pivot 12, wherein this rotation takes place by means of a front shaft 25. From a mechanical point of view, a front pivot receptacle 10, which is fixed on the front tube 11, is provided, in which the front shaft 25 is pivot-mounted. Through this degree of freedom of the steering ski 3 with respect to the frame 1, it is possible to create a steering movement, thereby inducing a change in the direction of travel 14 of the tilting vehicle. Depending on the angle of first front pivot 12 with respect to the frame direction 9, pivoting the first front pivot 12 also allows the front ski 3 to catch an edge with the ridden slope. The angle of the front pivot receptacle 10 with the frame direction 9 (please refer to FIG. 4) is preferably around 60 degrees to insure an optimal edge catching between the steering ski 3 and the ridden slope.

Furthermore, the connection of the steering ski 3 to the frame 1 is such that the steering ski 3 is pivot-mounted, relative to the frame 1, around a second front pivot 13, which is fixed relative to the front shaft 25. The second front pivot 13 extends in a horizontal direction which is normal to the direction of travel 14. Through this degree of freedom of the steering ski 3 with respect to the frame 1, it is possible to compensate for unevenness in the terrain on which the tilting vehicle is moving. The steering ski 3 therefore adapts itself without the need for any intervention of the passenger regarding the instantaneous inclination of the terrain.

Instead of one single steering ski 3, two skis parallel to each other can be fastened to the frame 1, such that they both pivot around the first front pivot 12 and the second front pivot 13. The steering ski can also be in the form of a skid, which is used for the sliding on ice. Such a skid is preferably made of metal, is very thin and has sharp outer edges.

As an alternative to the use of a first and a second front pivot, a universal joint or a ball and socket joint can be used.

In order to control the angle of the steering ski 3 with respect to the frame 1 around the first front pivot 12, feet sustainers 15 are provided, which are rigidly fixed to the steering ski 3 with respect to the first front pivot 12. When the passenger applies his feet on the feet sustainers 15, he has the possibility of pushing his legs differently on each feet sustainer, in order to rotate the steering ski 3, in one direction or the other, with respect to the first front pivot 12. This way, he is able to modify the direction of travel 14 of the tilting vehicle with respect to the ridden slope.

### Vehicle Length Adjustment

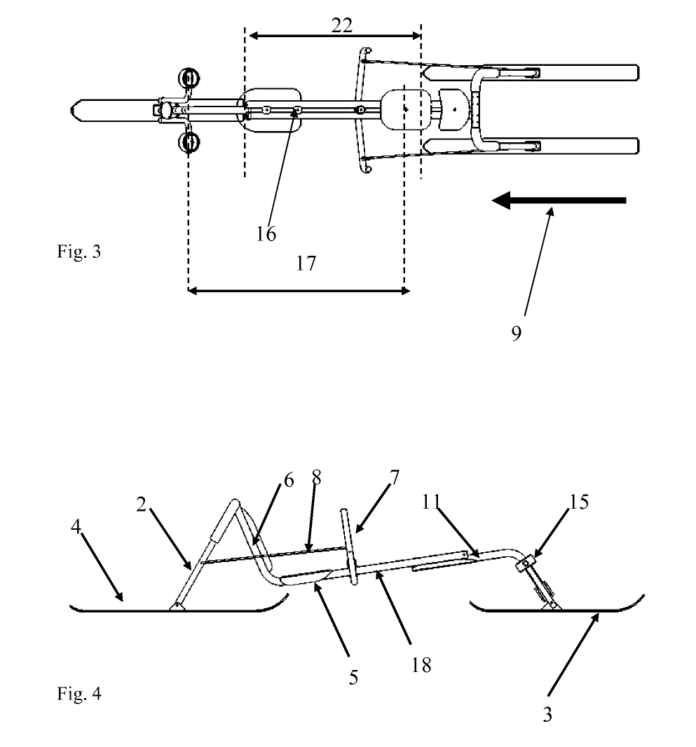

It is preferable that the tilting vehicle be adjustable to different passengers having different body sizes and/or different length of legs. In the present embodiment, the front tube 11 of the frame 1 can slide continuously along the rear tubes 18 of the frame 1 thereby adjusting the distance 17 between the feet sustainers 15 and the seat 5 (please refer to FIG. 3). The said distance 17 should be adjusted according to the passenger height, such that the knees of the passenger are bent when the steering ski 3 points straight away in the frame direction 9, i.e. when the direction of travel 14 is identical with the frame direction 9. This way, the passenger still has some “spare length” in his legs and can further extend one of them in order to steer the steering ski 3.

Fixing devices 16 such as screws or quick release levers are provided in order to lock the front tube 11 of the frame 1 longitudinally with respect to the rear tubes 18 of the frame 1 in the adjusted position corresponding to the required distance 17 between the feet sustainers 15 and the seat 5.

### Fastening of the Tilting Skis:

Both tilting skis 4 are pivot mounted at a lower end of the tilting arm 2, around a rear pivot 19, with respect to the tilting arm 2. When the tilting control device 7 is symmetric with respect to the frame 1, as shown in FIGS. 1 and 2, the rear pivots 19 extend in a horizontal direction which is normal to the frame direction 9. Through this degree of freedom of the tilting skis 4, it is possible to compensate for unevenness in the ridden slope without any intervention of the passenger.

Here also, each of the tilting skis 4 can also be in the form of a skid, which is used for sliding on ice. Such a skid is preferably made of metal, is very thin and has sharp outer edges.

### Tilting Arms

The two tilting arms 2 are symmetric and pivot inside the upper pivot receptacle 20, around the upper pivot 21. When the tilting control device 7 is symmetric with respect to the frame 1, as shown in FIGS. 1 and 2, the upper pivot 21 extends in a horizontal direction which is normal to the direction of travel 14, or to the frame direction.

The two tilting arms 2 can be made of tubes having the same properties as the frame material.

The distance between the upper pivot 21 and each of the rear pivots 19 is preferably around 53 cm for a tilting vehicle designed to transport adult passengers.

### Tilting Control Device

The tilting control device 7 is pivot mounted on the frame 1, around a middle pivot 23. The tilting control device 7 extends, at least partially, under the rear tube 8, thereby allocating more space for the legs of the passengers. The tilting control device 7 is preferably V-shaped, wherein each leg of the V ends with a vertical section, which is used as a handgrip, thereby allowing the passenger to actuate, through his hands, the tilting arms 2 my means of the connecting elements 8. For a tilting vehicle designed to transport adult passengers, the distance between the two vertical sections is preferably 55 cm, and the distance between the two points, where the two connecting elements 8 are fastened to the tilting control device 7, is preferably 45 cm. The maximum tilting angle of the tilting control device 7 with respect to the middle pivot 23 is preferably 35 degrees.

The tilting control device 7 is preferably made of tubular material, which has the same characteristics as the above described frame 1

### Connecting Elements

Each connecting element 8 is fastened with one end on one V-leg of the tilting control device 7 and with its other end on the corresponding tilting arm 2. The connecting elements 8 transmit the movement between the tilting control device 7 and the tilting arms 2.

The connecting elements 8 are fastened on the tilting arm 2, at a position, which assures an adequate distance to the upper pivot 21, measured in the vertical direction; this distance is preferably 30 cm, for a tilting vehicle designed to transport adult passengers. The connecting elements 8 therefore allow the tilting arms 2 to function as levers in order to control the angular position of the tilting arms 2 around the upper pivot 21.

The connecting elements 8 can be in the form of stiff elements like rods and tubes, which can transmit both compression and tensile forces, or be made of soft elements like wires or cables, which can only transmit tensile forces.

### Adjustment of the Tilting Angle (Please Refer to FIGS. 7, 8 and 9):

The tilting arms 2, through their connection to the tilting control device 7 using the connecting elements 8, pivot in opposite directions to each other.

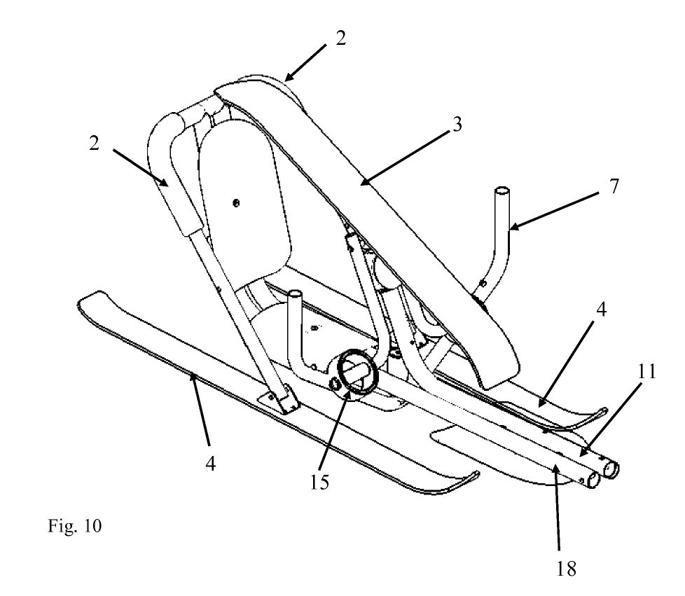

The tilting arms 2 should be rotated within a well defined angular range in order to insure the desired functioning of the tilting vehicle. In particular, the tilting arm 2 should not be allowed to reach a vertical position or rotate beyond it, since this would result in opposite tilting effects on the tilting vehicle. In other words, each rear pivot 19 should not reach a position where it is vertically under the upper pivot 21, or still worth go beyond it. The tilting arms 2 should not reach, for example, their position shown in FIG. 10, which just illustrates the tilting vehicle in the folded position.

On the other hand, each tilting arm 2 may not reach a position, wherein the angle between the frame direction 9 and the tilting arm 2 is close to zero degrees; this would require a very large force to pull that tilting arm 2 back again in the frame direction 9, due to the non linearity of the sine and cosine trigonometric functions. It is therefore preferable that the maximum angle between a tilting arm 2 and the frame direction 9 does not become smaller than 20 degrees.

In particular, it is preferable that the tilting arms 2 operate within an angular range where both rear pivots 19 remain behind the upper pivot 21, seen in the frame direction 9, thereby allowing the use of connecting elements 8, such as cables, which cannot transfer any compression force, wherein just the gravity force pulls the tilting ski 4 backwards, i.e. against the frame direction 9, thereby maintaining a tension in the connecting element 8.

It is also preferable that a rearward movement of a tilting arm leg induces a downward movement of the tilting vehicle on the side of said leg of the tilting arm 2, thereby allowing the passenger to better lean inwards, i.e. towards the centre of the curve along which the tilting vehicle is moving.

Avoiding that the tilting arms rotate beyond their defined tilting range can be insured at the level of the tilting control device 7; an easier and safer solution is to insure it at the level of the tilting aims 2, wherein a limiting cable (not shown in the figures) connects both tilting aims 2 together, preferably at the same level at which the connecting elements 8 are fastened to the tilting arms 2. In a preferred embodiment, the limiting cable is integrated in the connecting elements, wherein the limiting cable and both connecting elements are made of a single cable or wire. This solution is particularly useful for the case in which, the connecting elements 8 are made of cables for example, which cannot transmit any compression force. The length of the limiting cable dictates the maximal allowed relative angle between the two tilting anus 2, resulting in the implicit definition of the maximal and minimal angles of each tilting arm 2 with respect to the frame direction 9. In the position where both tilting arms 2 are parallel to each other, i.e. when the tilting control device 7 is positioned symmetrically with respect to the frame 1, the limiting cable has no tension force in it.

The pivoting movement of the tilting arm 2 around the upper pivot 21 is defined so that each arm can be rotated between a maximal angular position corresponding to a maximal angle between the tilting arm 2 and the frame direction 9, and a minimal angular position corresponding to a minimal angle between the tilting arm 2 and the frame direction 9. In the maximal angular position of a tilting arm 2, the rear pivot 19 is positioned almost vertically under the upper pivot 21. In the minimal angular position, the tilting arm 2 rather extends backwards against the frame direction 9, pulling the tilting ski 4 with it, under the influence of the gravity due to the weight of tilting vehicle and that of the passenger sitting on it, thereby increasing the distance 22 of the tilting ski 4 to the steering ski 3 (please refer to FIG. 3). In the case of stiff connecting elements 8, the backward movement of the tilting arm 2 is further assisted by the compression force that the connecting element 8 transmits from the tilting control device 7.

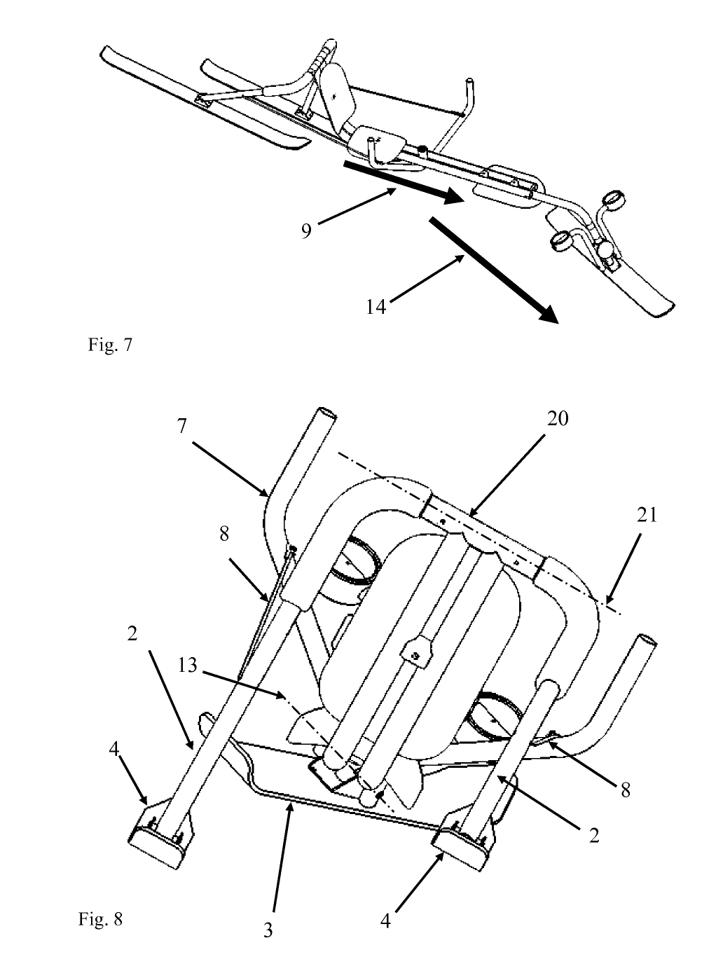

Through the pivoting movement of the tilting arms 2 around the upper pivot 21, the tilting skis 4, which are fixed at the lower ends of the tilting arms 2, are moved vertically in opposite directions with respect to the frame, thereby allowing the tilting skis 4 to catch an edge with the ridden slope (please refer in particular to FIG. 8).

The maximal angular position of the tilting arm 2 relative to the frame direction 9 is preferably 85 degrees. When the tilting control device 7 is positioned symmetrically with respect to the frame 1, as shown in FIG. 1, the angular position of both tilting arms 2 relative to the frame direction 9 is preferably 60 degrees.

FIG. 8 shows the tilting vehicle whereby the tilting skis 4 feature different heights with respect to the upper pivot 21. Simultaneously, the steering ski 3 is pivoted around the frame 1, in order to change the direction of travel. This is an operating mode which is typically used when the tilting vehicle is moving along a curve.

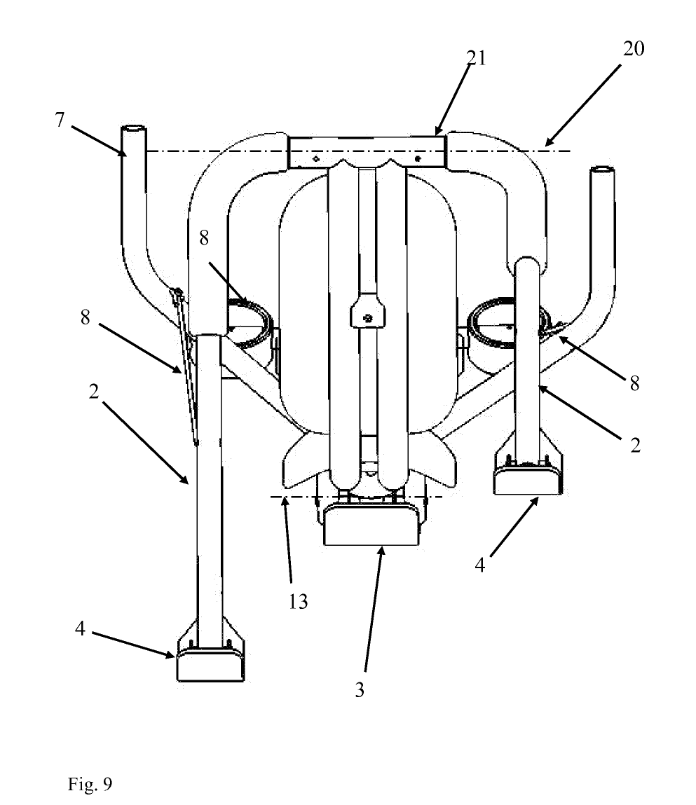

FIG. 9 shows the tilting vehicle, wherein the tilting skis 4 also feature different heights with respect to the upper pivot 21. However, the steering ski 3 is pointing in the frame direction 9. This operating mode is typically used when the tilting vehicle is moving straight on, i.e. without any change in the direction of travel 14, in a direction which is transverse with respect to the slope. This operating mode allows the passenger and the frame 1 to remain sensibly oriented vertically, i.e. in a non-tilted position, assuming that the tilting control device 7 is adjusted correctly, while the tilting skis 4 and the front skis 1 catch an edge with the slope. This “canting” is compulsory to avoid the tilting vehicle from sliding sideways down the slope.

### Folded Position (Please Refer to FIG. 10).

FIG. 10 shows the tilting vehicle in a folded position.

The front steering assembly of the tilting vehicle comprising mainly the steering ski 3, the feet sustainers 15 and the front tube 11 is fastened on the upper side of the rear tubes 18, in a direction which is opposite to that of the operating modus. The same fixing device 16 can be used to fasten the front assembly on the rear tube 18 in the shown position.

The tilting arms 2 and the tilting skis 4 are pivoted around the upper pivot 21 such that the tilting skis 4 are brought to their foremost position under the seat 5. If the connecting elements 8 are made of stiff rods or tubes, they should be dismantled at one end, at least, in order to allow folding the tilting arms 2, Alternately, the stiff connecting elements 8 can be made of telescopic elements, which slide within each other, and whose length can be adjusted, where at least one length corresponds to the operating modus position and the other length corresponds to the folded position.

In case the connecting elements 8 are made of cables or wires, folding the tilting arms 2 to the position shown in FIG. 10 does not constitute any problem since the tilting arms 2 are moving closer to the tilting control device 7 then during the operating mode; the connecting elements 8 would not have any tension force in them in the folded position.

The tilting skis 4 and the steering ski 3 can further be dismantled from the tilting vehicle by using quick release levers for example.

### 2^{nd} Embodiment

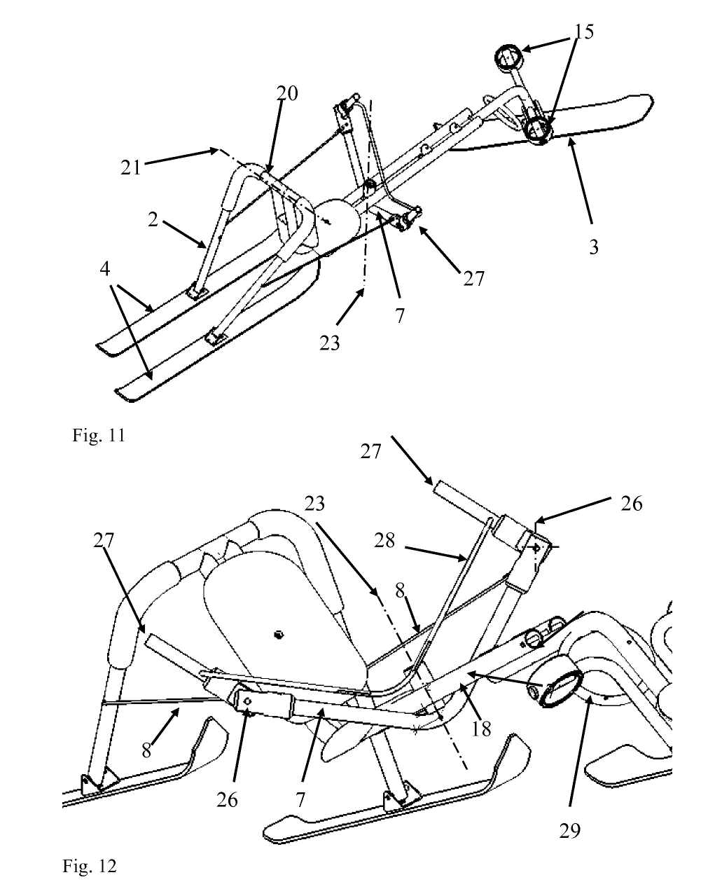

### Tilting Control Device Comprising a Steering Function (FIGS. 11 & 12)

As an alternative to a steering movement which is actuated by foot, a hand-actuated steering is necessary for persons with a limited mobility at the leg level. This embodiment illustrates a tilting vehicle similar to that described in the 1^{st} embodiment, wherein the tilting control device 7 also includes a tilting function. As in the 1^{st} embodiment, the tilting control device 7 is pivot-mounted around the middle pivot 23. In addition, the tilting control device 7 comprises at least one steering lever 27, which is pivoted around the rear steering pivot 26. In FIGS. 11 and 12, two steering levers 27 are illustrated, which are connected together by a connecting rod 28. The connecting rod 28 allows to coordinate the rotation of both steering levers 27 as well as eventually to transmit a steering force from one lever to the other, in case one hand of the passenger is weaker than the other. At least one non-illustrated cable connects the steering levers 27 to the feet sustainers 15, by means of the steering cable holder 29, wherein the pivoting movement of the steering levers 27 is transferred as a pivoting movement of the steering ski 3 around the first front pivot 12. This mechanism would also function properly with just one steering lever, and without any connecting rod.

### 3^{rd} Embodiment

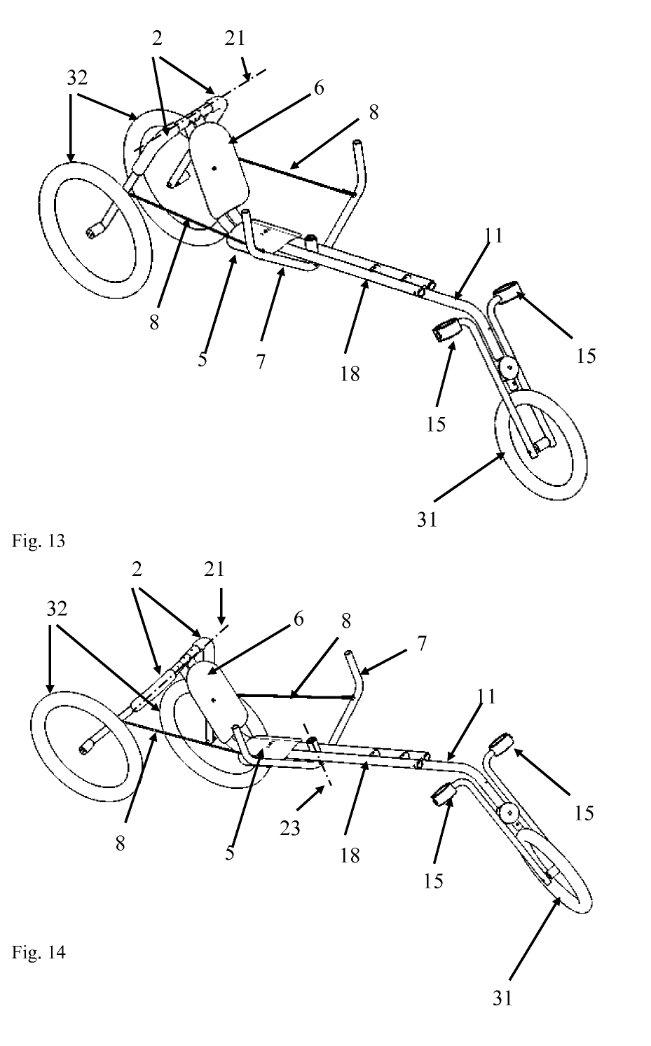

### Tilting Vehicle Using Wheels (FIGS. 13 & 14)

In this embodiment, a tilting vehicle is shown using wheels instead of skis. Apart from this difference, the movement of this vehicle is exactly identical with that of the tilting vehicle described in the first embodiment.

In FIG. 13, the vehicle is driving straight one and both rear wheels 32 are at the same height with respect to the frame 1.

In FIG. 14, the vehicle is driving along a curve: the front wheel 31 is tilted with respect to the frame direction 9, and the tilting control device 7 is pivoted around the middle pivot 23, thereby tilting the whole vehicle.

The illustrated vehicle does not comprise pedals and is used primarily to be drive downhill.

The control behavior of the tilting vehicle in any of the afore described embodiments can be influenced by having one or more of the following parameters continuously or discretely adjustable:
the distance between the tilting arms 2,
the distance between the connecting elements 8 at the level of the tilting control device 7,
the distance between the rear pivots 19 and the upper pivot 21,
the vertical position of the fastening points of the connecting elements 8 on the tilting arms 2, with respect to the upper pivot 21
   wherein the driving style can be tuned to be anywhere between a “sporty” style and a “relaxed” style.

### Non-Illustrated Embodiments

According to a further non-illustrated fourth embodiment, the tilting vehicle is designed for two or more passengers, wherein the passenger sitting in the front, with respect to the direction of travel, controls the direction of travel, while the at least one rear passenger actuates the tilting control device.

According to a fifth embodiment which is not illustrated, the passenger lies on his abdomen in the frame direction 9, wherein the steering ski is positioned at the front end of the tilting vehicle, and the tilting skis are positioned at rear end if the frame, similar to the three afore described embodiments. Instead of a seat, a body support is provided, on which the at least one. Furthermore, the direction of travel 14 is controlled directly by hand. The tilting control is achieved by a direct or indirect feet actuation of the tilting arms. In order to synchronize the movement of both tilting arms and better control the induced forces, a flexible cable or wire can be provided, which connects both tilting arms together, and which is guided around a pulley, wherein said pulley is pivot-mounted on the frame.

According to a sixth embodiment which is not illustrated, the steering ski is positioned at the rear end of the tilting vehicle, and the tilting skis are positioned at the front of the tilting vehicle. As in embodiment 4, the passenger lies on his abdomen. Furthermore, the direction of travel can be controlled by the feet, wherein the passenger moves the steering ski directly or by actuating the feet sustainers. The tilting control is then achieved by a direct hand actuation of the tilting arms. In order to synchronize the movement of both tilting arms and better control the induced forces, a flexible cable or wire can be provided, which connects both tilting arms together, and which is guided around a pulley, wherein said pulley is pivot-mounted on the frame.

A braking device, which can be actuated by hand or by foot, can be provided in all of the afore described embodiments.

What is claimed is:

1. A tilting vehicle for the transport of at least one passenger on snow, ice, grass, sand or water, comprising:
a frame featuring an upper pivot,
at least one steering ski, wherein said steering ski is pivot-mounted with respect to said frame, in order to change the direction of travel;
two titling arms, which are pivot-mounted, with their respective first ends, on said frame around said upper pivot; wherein said upper pivot extends in the frame direction, wherein said frame direction extends parallel to the longitudinal direction of both tilting skis and frame, thereby pointing at least partially in the direction of travel.
two titling skis, wherein each said tilting ski is pivot-mounted at the respective second ends of each said tilting arm, wherein said tilting skis can be vertically adjusted with respect to each other and with respect to said frame.

2. A tilting vehicle according to claim 1, wherein said at least one steering ski can be pivoted through the feet of said at least one of the passengers.

3. A tilting vehicle according to claim 2, wherein feet sustainers are provided for the feet of said at least one of the passengers, wherein said feet sustainers are indirectly fixed with respect to said at least one steering ski.

4. A tilting vehicle according to one or more of the previous claims, wherein the distance between said feet sustainers and said at least one passenger is adjustable.

5. A tilting vehicle according to one or more of the claims 1 to 4, comprising a tilting control device, wherein said tilting control device allows the angular adjustment of said tilting arms in opposite directions around said upper pivot, such that the tilting skis can be vertically adjusted with respect to each other and with respect to the frame, thereby controlling the tilting angle of the tilting vehicle.

6. A tilting vehicle according to claim 5, wherein said tilting control device is actuated through at least one hand of said at least one passenger.

7. A tilting vehicle according to at least one of the previous claims, wherein said steering ski, used to change the direction of travel, is positioned at the front end of the frame, and said two tilting arms are positioned in the rear end of the frame, wherein said front end and said rear end of the frame are viewed with respect to the direction of travel.

8. A tilting vehicle according to at least one of the previous claims, wherein the angle between each said tilting arm and the frame direction ranges between 5 and 70 degrees, wherein this angular range defines the operating range of the said tilting arm.

9. A tilting vehicle according to at least one of the claims, wherein said tilting arms are connected to said tilting control device using connecting elements, wherein said connecting elements are made of flexible elements, such as wires or cables, which cannot transmit any compression force, or of stiff tubes or rods, which can transmit both compression and tensile forces.

10. A tilting vehicle according to at least one of the previous claims, wherein said tilting vehicle comprises two seats and two back rests for the transport of two passengers.

11. A tilting vehicle according to claim 10, wherein said first seat is fixed on said frame such that said first passenger sitting on said first seat can actuate said feet sustainers, wherein said tilting control device is fixed on said frame, such that said second passenger sitting on said second seat can actuate said tilting control device.

12. A tilting vehicle according to one of the previous claims, wherein said frame has a S shape, wherein the straight ends of said frame are parallel to each other.

13. A tilting vehicle according to one claim 1, wherein a body support is fixed on said frame or is integrated in said frame, wherein said at least one passenger lies on his abdomen on said body support.

14. A tilting vehicle according to claim 13, wherein the adjustment of the tilting of said tilting vehicle can be achieved through the rotation of said tilting arms around said upper pivot, wherein this rotation is achieved directly by hand or feet without any intermediate device.

15. A tilting vehicle according to one of the previous claims, wherein the maximal angle between the two said pivoting arms is limited by a limiting cable, wherein said limiting cable is fixed on its first end on the first titling arm, and on its second end, on the second tilting arm, wherein the two fixing points of said limiting cable on said tilting arms are preferably in the same position as the fixing points of said connecting elements on said tilting arms.

16. A tilting vehicle according to one of the previous claims, wherein the rotational position of said steering ski around said first steering pivot can be controlled by means of the tilting control device, wherein said tilting control device comprises pivot-mounted levers.

17. A tilting vehicle according to claim 13, wherein said steering ski can be actuated by feet and the tilting skis can be actuated by hand.

18. A tilting vehicle according to claim 13, wherein said steering ski can be actuated by hand and the tilting skis can be actuated by feet.

19. A tilting vehicle according to one of the previous claims, wherein the distance between said steering ski and the passenger can be adjusted by adjusting the length of said frame, wherein said frame is made of at least a front part and of a rear part, wherein said front part and said rear part of said frame can slide on each other.

20. A tilting vehicle according to one of the previous claims, wherein the steering and tilting skis are replaced respectively by steering and tilting wheels, allowing thereby the tilting vehicle to roll on the ground.
